(19) United States
(12) Patent Application Publication
(10) Pub. No.: US 2008/0080010 A1
(43) Pub. Date: Apr. 3, 2008

(54) Easy Copying Between Electronic Paper And Display

(75) Inventor: Johannes Henricus Maria Korst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,905

(22) PCT Filed: Oct. 10, 2005
(86) PCT No.: PCT/IB05/53317

§ 371 Date: Apr. 9, 2007

(30) Foreign Application Priority Data
Oct. 13, 2004 (EP) 04105023.8

(51) Int. Cl. H04N 1/00

(52) U.S. Cl. 358/401; 345/55; 358/400

(57) ABSTRACT

A method and devices for copying an image (2) from an electronic display (1) to an electronic paper (3), wherein said electronic paper (3) is held against an area (6) of the electronic display (1) for performing a copy action and that said electronic display (1) comprises identification means for determining the borders of the area (6), a copy set button included in said devices for initiating the copy action, circuits for establishing a wireless connection between the display (1) and the paper (3) and a processor (5) for reading image information from the area (6) of the electronic display (1) for sending the image information to the electronic paper (3) for the display of the image (2) comprised in said area (6) of the electronic display (1) on the electronic paper (1).

### TECHNICAL FIELD

The present invention refers to easy transfer of images, text, etc. between electronic paper and a display by simply placing the electronic paper face to face to the display.

### BACKGROUND OF THE INVENTION

Recently, light sensitive displays have been proposed that have the ability to scan a paper that is kept in front of and facing the display. This offers the possibility to transfer text and images from e.g. an electronic paper to the display, but not the other way around. The display (such as a light sensing polyLED screen) might be in the form of a table, into which a display is incorporated, a large display attached to a wall, or a portable display (as a part of a PDA or a lap top).

The electronic paper discussed herein may consist of, as one example, an active matrix display achieved on fine paper, or a product similar to paper, using a combination of common printing techniques. The active matrix display consists of transistor switches that individually control the matrix display elements providing addressing of each display element in a cross-point matrix. Letter sized matrix displays have been demonstrated (an example is the ebook launched in April, 2004 by Sony Corp. as a result of work by the partners Toppan Printing, Philips, Sony and E Ink Corp.). The paper matrix display technology can extend existing use of paper as a displaying medium, such as in advertisement, updateable information poster, and in smart packaging concepts etc.

### PRIOR ART

EP 0 131 342 discusses a light sensitive photoconductor involving an electrophoretic suspension sandwiched between two transparent electrodes, whereby a light image may be obtained on the photoconductor by projecting a light image on said photoconductor. A laser for writing images onto the photoconductor and video systems for recording images from a CRT monitor makes it possible to achieve a copy of the image displayed on the CRT on the photoconductor, which can be thin and of letter format.

The technique used in said document may not be used for copying images from other kind of displays, such as LED or LCD screens.

### OBJECT OF THE INVENTION

One object of the invention is to provide a device and a method for copying an image from an electronic display, such as a LED, an LCD or polyLED screen to an electronic paper. Especially, it is advantageous to provide a device and a method for copying image in both directions, from the electronic paper to the screen or from the screen to the electronic paper.

### DISCLOSURE OF THE INVENTION

According to one aspect of the present invention there is disclosed a method as specified in the independent method claim.

According to a further aspect of the invention there is disclosed an electronic display and an electronic paper as specified in the independent device claims.

It is understood herein that the electronic display is provided with a screen for displaying images. Further, herein it is also defined that the electronic paper is displaying images on a face included in the electronic paper. It is further assumed here that the screen of the electronic display has greater area than said face of the electronic paper.

A processor attached to said electronic display processes data containing the image information for adapting semantic information, such as fonts and layouts, to characteristics of the electronic paper. Since data is transmitted in digital form said processor can be used to adapt the way the image information is displayed on the electronic book. Hence, in this way, other fonts than fonts eventually depicted on the identified area of the electronic display can be used for improving the image of the area copied, such as the readability of texts included. The layout of the image depicted on the face of the electronic paper may further be improved if layout information is provided in the wireless connection established between the electronic paper and the electronic display. As both devices have information in digital form, the information exchange between the electronic display and the electronic paper may be provided on a higher semantic level. Thus, if for example the information contained in the area copied is a Word-file or part of a Word-file, then at least a part of the information transmitted to the electronic paper may be sent as a Word-file and in a corresponding way if the processor identifies other file-formats present in the area to be copied.

The processor of the electronic display can further adjust the copied image in relation to a small skew, which is the result of an incorrect aligning of the electronic paper. Such incorrect aligning may be a result of columns and rows of the cross point matrix of the electronic paper being inclined in relation to the corresponding columns and lines of the cross point matrix of the screen of the electronic display. The correction may be performed by copying the extreme coordinates (lowest and highest coordinates) of lines and rows, respectively, of the area copied to the electronic paper for transforming the area covered on the electronic display to a rectangle with comers on these extreme coordinates.

When copying from an electronic paper, which may be provided as an electronic book, to the display which is known in the art, the processor that renders the image that is visible on the display has to be involved in the processing of the images. In principle, the same techniques can then be used to realize the copy according to the present invention by combining the light sensing abilities of the display with the use of the wireless connection between the electronic paper and the display. In this case a processor in the electronic display is involved to make an image visible on the display. Equivalent actions must be performed if the copy of the displayed image for storage or use on the electronic paper is to be displayed also on the display, which may be wanted if the display autonomously is set to display the copied area for at least a few seconds (e. g. more than 2 seconds), for example, in a separate window, just to give the user a confirmation of that the copy action has been carried out successfully. Data containing the image information for this confirmation copy can be stored in some local storage built-in into the display. Another possibility is to store the data for the confirmation copy on an appropriate storage device.

The identification of the borders of the area to be copied from the display to the electronic paper is according to one embodiment performed by means of the light sensitive elements of the display, whereby the area of the display covered by the electronic paper can be identified and determined.

The above described embodiment of the invention assumes that the display has light sensing capabilities. An other way to determine the position of the face of the electronic paper that is held before the display is to use an influence of an electric field, that the electronic paper performs on the display. The electronic paper influences the electro- magnetic field around the display. If the electron paper is set to transmit its characteristics (size, etc.), that relate to the way that it is likely to influence the electromagnetic field around the display, then a display can be used for the copying action according to the aspect of the invention also if the display lacks light sensing capabilities. The detection of changes of the electromagnetic field may be provided, e.g. by means of electromagnetic field sensors positioned on the corners of the screen of the electronic display.

In a further embodiment the display is provided with a number of micro-beacons, that the electronic paper can use to determine its exact position in front of the display. Said micro-beacons are provided in a known pattern throughout the display and used by the electronic paper for said identification.

The electronic display referred to in this document can as well be a display of the same or similar type as the one used for the electronic paper, provided that the display has light sensing functionalities of any embodiment discussed herein.

A memory for storing said data containing the image information for later displays of said image on the electronic paper is included in electronic circuits provided on said electronic paper.

An advantage arrived at by use of the present invention is the provision of an easy and intuitive copying between an electronic display and an electronic paper.

These and other aspects of the invention will be apparent from and elucidated with reference to the embodiment(s) described hereinafter.

Application of the present invention is especially convenient when there is a need of transfer of information between fixed and portable electronic devices.

### BRIEF DESCRIPTION OF THE DRAWINGS

FIG. 1 discloses schematically a perspective view of the copying procedure when an image is copied from an electronic display to an electronic paper.

FIG. 2 schematically shows the electronic paper held against the electronic device over area of the electronic device and at least covering the image to be copied.

### DESCRIPTION OF PREFERRED EMBODIMENTS

A number of embodiments for performing the method according to the invention will be described in the following supported by the enclosed drawings.

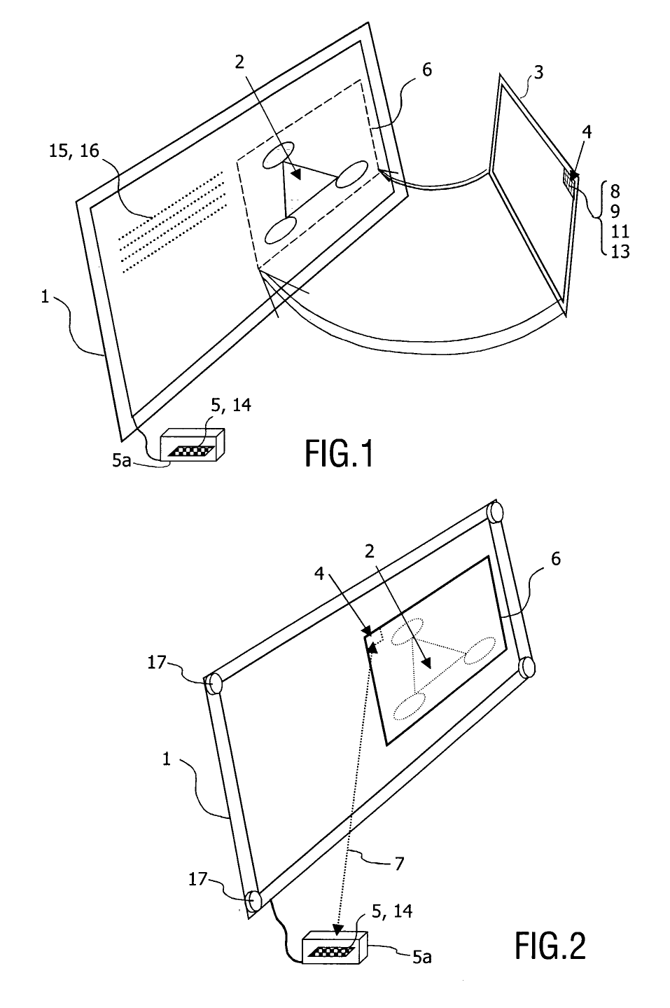

FIG. 1 discloses an electronic display 1 (such as a light sensing polyLED screen), which might be in the form of a table, into which a display is incorporated, a large display attached to a wall, or a portable display (as a part of a PDA or a lap top). On the screen of the electronic display 1, there is depicted an image 2. It is an object according to the invention to copy said image 2 from the electronic display 1 to an electronic paper 3. The electronic paper 3 is provided with a circuit 4 containing transceiver circuits 13 for establishing a wireless connection with the electronic display 1. As an option the electronic paper can be provided with a memory 8 for storing said image data. Said memory 8 may advantageously be included in the circuit 4.

The electronic display 1 is further provided with a processor 5, which may be a separate processor for monitoring the electronic display and in the figures illustrated to be housed in a unit 5a. As an alternative said processor 5 might be included in the processors of a computer of which the electronic display is a unit.

To initiate a copying action the electronic paper 3 is held against the electronic display 1 in a manner such that the image 2 that is to be copied is covered by the electronic paper 1, in the way shown in FIG. 2. The electronic paper 3 will normally cover a greater area 6 than the area of the image 2, where the borders of area 6 covered by the electronic paper in FIG. 1 are indicated by means of a dashed line.

When the copying action is to be initiated, this is ordered by means of a triggering device. Said triggering device might be performed as a copy setting button 9 included in the electronic paper, for example in the form of a touch button included in the circuit 4. As an alternative a copy setting button 10 may be included in the unit 5a of the electronic display 1. A further alternative is to use a wireless control button, which activates the copying action. When the copy action is about.to be performed, the operator demands said copy action to be carried out by means of pressing a copy button 11, 12, which can be provided in the same way as the copy setting button.

The procedure for copying an image 2 according to the invention is here described step by step. The electronic paper 3 is held against the screen including the electronic display 1 in such a manner that at least the image 2 is covered by the electronic paper 3. This means that the electronic paper 3 covers an area 6 greater than the area occupied by the image 2. A copy action is triggered to be performed by pushing a copy setting button 9, 10. Said triggering establishes a wireless connection between the electronic paper and the electronic display. The wireless connection is performed by transceiver circuits 13 included in the circuit 4 of the electronic paper 1. At the electronic display 1, a corresponding device including transmitter and receiver circuits 14 for performing the wireless connection is activated. These transmitter and receiver circuits are in the example housed in unit 5a. The wireless connection is schematically shown in FIG. 2 by the numeral 7.

The processor 5 starts to identify the area 6 covered by the electronic paper 3. This may be performed in different ways as indicated above and in further embodiments below. The identification includes a determination of the coordinates of the borders of the area 6. As the electronic paper 3 could be skewed in relation to the borders of the electronic display 1 a determination of the corners of the area 6 can be performed in a manner where a mis-alignment is corrected. An image shown on a display is normally formed by pixels arranged at cross points of a matrix of lines and columns. If the processor 5 detects the corners of the area 6 by indicating the lowest and the highest coordinates of the horizontally aligned cross points of the matrix included in the area 6 of the display 1 and further the lowest and highest coordinates of the vertically aligned cross points of the matrix included in the area 6 of the display 1, a correctly aligned image included in the area 6 will be formed. The processor 5 can then read image data containing information for the complete picture displayed in the area 6. The image information is then transmitted via the wireless communication link 7 established to the transceiver circuits 14 of the electronic paper 3. The image may then be immediately displayed on the face of the electronic paper controlled by means of the circuit 4 monitoring the display of the electronic paper. When a memory 8 is included in the electronic paper 3 as a storage connected to the circuit 4, the image 2 may be later displayed on the electronic paper 3 by means of a control of the time when the image should be shown on the face of the electronic paper 3.

According to an alternative embodiment it is further arranged that the light sensitive display determines the outer borders of the area 6 covered by the electronic paper 1 and that the processor 5 adds a frame around said border. The portion of the display including both the area 6 and the frame can then be programmed to show the depicted images/texts of the display 1 in another style, such as a different colour of the text and the images included in said area and frame. In this way, when the electronic paper is moved around on the screen of the display, said electronic paper is functioning as if it is painting the area covered by the electronic paper plus the frame around said area. By the use of this embodiment it is advantageous to arrange that the processor reads the content of the area covered by the electronic paper plus the frame, whereby a larger area 6 is copied to the electronic paper than only the area covered by the electronic paper. By the use of this embodiment it will be much simpler for a user when copying according to the invention, as it is much easier to visually identify the area 6 to be copied. When the user can visually observe that the desired area 6 to be copied is identifying itself, he can demand the start of the copy action when the desired area to be copied is actually appointed.

In still a further embodiment, where a much greater area is to be copied from the electronic display 1 to the electronic paper 3 than the area available on the display area of the electronic paper 3, it is possible to move the electronic paper 3 around on the screen of the electronic display 1 and thereby let the electronic paper 3 paint the area to be copied in the way described in the preceding paragraph. This function may be achieved in a way such that the processor 5 stores the lowest coordinates (line and column) of the pixel in the cross point matrix generating images on the electronic display 1 and in the same way stores the highest coordinates (line and column) of the corresponding pixel for the area that is touched or covered on the screen of the electronic display 1 by the corners of the electronic paper 3 at any time during the “painting” movement with the electronic paper 3. The actual area 6, which will be copied is then a rectangular represented by two opposite comers positioned on these cross points described. This will of course lead to a reproduction of the images to be copied in a smaller scale on the electronic paper 3 then the scale in which they are displayed on the electronic display 1. The scaling is performed by means of the processor 5. As a further alternative, only a part of the copied material is visualized on the electronic paper, offering the possibility to adjust a certain part of the material to be visualized.

According to a further embodiment the sensing elements on the screen of the display 1 detects only the area really covered by the electronic paper during its “painting” movement around the screen.

Extreme corners are in this description and in the claims used as terms for indicating the coordinates of two opposite comers of the area 6 to be copied. These could either be:
the two opposite corners of the screen of the electronic paper 3, or
the two opposite corners of the rectangular formed by the screen of the electronic paper including the frame arranged around the electronic paper or
the two corners of the rectangle generated by two opposite corners positioned on the cross points of the matrix having: a) the lowest line and column coordinates and b) the highest line and column coordinates of the area 6 painted by the, on the electronic display, moved around electronic paper 3.

In the figures, the light sensing elements 15 are represented by crosses arranged in rows and lines on the screen of the electronic display. The same crosses are also used to illustrate the micro beacons 16 to indicate their location when said beacons are used. Electromagnetic field sensors 17 are indicated at the corners of the electronic display 1 to indicate their position when such sensor are used. The elements 15 and 16 are only depicted on a portion of the screen in FIG. 1 for the sake of clarity. In reality these elements 15 and 16 are arranged over the whole area of the screen.

The wireless connection 7 between the electronic paper 3 and the electronic display 1 uses standard available technology, that has to be built into both the display 1 and the electronic paper 3.

It is not required that the light-sensing abilities of the electronic display 1 is of high resolution in this application. It suffices if the light sensing elements of the display reasonably accurate can determine the boundaries of the electronic paper when it is held against the display.

Furthermore, it should be noted that the computer that is attached to the display is not involved in the copy action. The demands on the electronic display 1 is that it is provided with the means for wireless connection and some arrangement for determining the area 6 to be copied and means for the control of the readout of the image data of that area 6. All this can be realized by the separate processor 5. However, the recognition of the area 6 and the readout of the information present in said area 6 may, as an alternative, be implemented by a communication between the processor 5, that is attached to the electronic display 1 and the processor that is integrated in the circuit 4 of the electronic paper.

The processor 5 may of course also be provided with programs supervising the semantics of the video information sent to the electronic paper 3 as described earlier. The electronic paper 3 can, e. g., in the copy request signal, include demands for a requested font and/or layout.

### Definition of Terms Used in this Document

An electronic display is a screen using light emitting elements, such as LED-, LCD-, and polyLED-screens or implemented by means of a corresponding display technology, wherein there is provided light sensing abilities. The electronic display could as well be a display of the same or similar type as the one used for the electronic paper, provided that the display is equipped with light sensing functionalities of any embodiment discussed herein.

1. Method for copying an image (2) from an electronic display (1) to an electronic paper (3) having light displaying elements arranged in a cross point matrix, comprising the steps of:
setting the electronic paper (3) to request a copy from said electronic display (1),
establishing a wireless connection (7) between said electronic display (1) and said electronic paper (3),
placing an electronic paper (3) against the electronic display (1),
covering the electronic display (1) on at least a part of an area (6) including said image (2) to be copied with said electronic paper (3),
identifying in said electronic display (1) the borders of the area (6) to be copied,
demanding the copy action to be carried out,
processing, in said electronic display (1), data containing image information for said area (6) to be copied,
transmitting by means of said wireless connection the image information from the electronic display (1) to the electronic paper (3) and
displaying on said electronic paper (3) by means of said light displaying elements arranged in said cross point matrix a copy of the image (2) filling up said area (6) of the electronic display (1).

2. The method according to claim 1, further comprising the step of:
identifying the area (6) to be copied as the area, which at any time during the copy action until the demand of the copy action to be carried out is covered by the electronic paper (3),

3. The method according to claim 1, further comprising the step of:
storing in a memory (8) included in said electronic paper (3) said image information for later displays of said image (2) on the electronic paper (3).

4. The method according to claim 1, further comprising the step of:
processing in said electronic display (1) said image information for adapting semantic information, such as fonts and layouts, to characteristics of the electronic paper (3).

5. The method according to claim 1, further comprising the step of:
providing said image information as analogue video signals or as digital image signals.

6. The method according to claim 1, further comprising the step of:
performing said identification of the area (6) of the display (1) to be copied by means of light sensitive elements (15) included in the display (1).

7. The method according to claim 1, further comprising the step of:
performing said identification of the area (6) of the display (1) to be copied by means of a detection of a change of the electromagnetic field around the display (1) in the area (6) which has been covered by the electronic paper (3).

8. The method according to claim 1, further comprising the step of:
performing said identification of the area (6) of the display to be copied by means of micro-beacons (16) provided in a known pattern of the display (1).

9. The method according to claim 1, further comprising the step of:
aligning the copy of the image (2) to be displayed on the electronic paper (3) with the image (2) displayed on the electronic display (1) in relation to the horizontal and vertical direction of rows and columns of light emitting elements as provided on the image (2) of the electronic display (1).

10. The method according to claim 1, further comprising the step of:
displaying a copy of the image (2) as it will be displayed on the electronic paper (3) on a window of the electronic display (1) for at least some seconds.

11. An electronic display (1) having light sensing elements (15) arranged in a cross point matrix of a screen of said display, for receiving an electronic paper (3) held against said screen for performing a copying of an image (2) from said electronic display (1) to said electronic paper (3), characterized in that the electronic display (1) comprises transmitter and receiver circuits (14) included in the electronic display (1) for establishing a wireless connection (7) between the electronic display (1) and the electronic paper (3), identification means (15, 16, 17) for determining the borders of an area (6) of said screen covered by said electronic paper (3), a processor (5) for reading data representing the image displayed on said area (6) of said screen for a transmission of said data to the electronic paper (3) by means of said wireless connection.

12. The electronic display according to claim 11, wherein said identification means includes light sensing elements (15).

13. The electronic display according to claim 11, wherein said identification means includes electromagnetic field change detection means (17).

14. The electronic display according to claim 11, wherein said identification means includes micro-beacons (16) provided in a known pattern of the display (1).

15. An electronic paper (3) having light displaying elements arranged in a cross point matrix on a face of said electronic paper (3) and adapted to perform a copying of an image (2) from a screen of an electronic display (1) when said face of the electronic paper (3) is held against the screen of the electronic display (1),
characterized in that the electronic paper (3) is provided with:
transceiver circuits (13) included in the electronic paper (3) for establishing a wireless connection (7) between the electronic display (1) and the electronic paper (3),
processing means in a circuit (4) for receiving data representing the image (2) on said electronic display (1) from said transceiver circuits (13) and for re-establishing said image (2) on said face of the electronic paper (3).

16. The electronic paper according to claim 15, wherein said transceiver circuits (13) are integrated into the electronic paper (3).

17. The electronic paper according to claim 15, wherein said electronic paper (3) includes a memory (8) for storing the data representing said image (2) for the display of said image (2) at a later occasion.
